(19) United States
(12) Patent Application Publication
(10) Pub. No.: US 2008/0042855 A1
(43) Pub. Date: Feb. 21, 2008

(54) In-ground border detector

(76) Inventors: Lisa M. Laurenzano, Somers, NY (US); Robyn Rao, Bronx, NY (US)

Correspondence Address: SUNG I. OH, PROFESSIONAL LAW CORPORATION, 710 QUAIL VALLEY LANE, WEST COVINA, CA, 91791, US

(21) Appl. No.: 11/500,741

(22) Filed: Aug. 8, 2006

(51) Int. Cl. G08B 23/00

(52) U.S. Cl. 340/573.4

(57) ABSTRACT

A system that is used to define a boundary of a home or the like so a child can be confined within the boundary includes a cable which is buried at the boundary, an activating element which is worn by a person being confined within the boundary and an alarm system that is activated when the activating element crosses the buried cable-defined boundary. Signs can be located near the boundary to provide a visible signal to the person that they are approaching the boundary. The alarm system can include elements worn by the person or other alarm signal generating elements.

### TECHNICAL FIELD OF THE INVENTION

The present invention relates to the general art of communications and to the particular field of condition responsive specific to human or animal location.

### BACKGROUND OF THE INVENTION

The safety and whereabouts of a child relative to a parent or other supervising individual in various surroundings has become an increasing concern. Over the years, monitoring or locating systems have been developed to monitor the location or proximity of a child or other object of interest. Oftentimes, an inquisitive child will stray out of sight of the guardian or parent, particularly in crowded areas such as shopping malls, and unless the child is continuously watched or monitored, the guardian may not know where to begin to look for the child. When the child remains unwatched, of course the threat of the child becoming separated, lost for a time, or even being kidnapped or otherwise lured away against the will of the guardian increases. Unfortunately, as a practical matter, little else can be accomplished if a guardian is required to continuously watch the child.

Children like to explore and child psychologists believe that exploration is important to a child's natural development. However, since a child is generally naive about the dangers in his environment, it is not generally regarded safe to permit a child to explore without close supervision. Since close supervision is not always convenient or possible, small children are placed in playpens and other confinements. If these confinements are used excessively, they can hinder healthy development of the child.

There have heretofore been proposed in the art a number of schemes and techniques for monitoring the range to or location of a person with respect to a monitoring station, such as the range to a child or patient. In general, systems heretofore proposed have been characterized by a high degree of cost and complexity.

Other systems aid in the recovery of a lost child. However, it is always better to know the moment a child strays or moves beyond a certain distance from a safe location than it is to recover a lost child. Simple mechanical arrangements are also known by which a young child can be kept within a certain distance of a parent or guardian. A tether or child “leash” arrangement by which an adult holds one end of a long strap connected at its other end to a harness worn by the child, is an example of a known device for ensuring that a child does not stray far and get into trouble without the parent's knowledge. Other systems may require the child to wear special shoes or the like. In such cases, the child can remove the article of clothing and the system will not function.

Therefore, there is a need for a means for confining a child to a particular area without hindering the child or without intrusive devices that the child may be tempted to remove.

### SUMMARY OF THE INVENTION

The above-discussed disadvantages of the prior art are overcome by a system that will be used to define a boundary of a home or the like so a child can be confined within the boundary. The system includes a cable which is buried at the boundary, an activating element which is worn by a person being confined within the boundary and an alarm system that is activated when the activating element crosses the buried cable-defined boundary. Signs can be located near the boundary to provide a visible signal to the person that they are approaching the boundary. The alarm system can include elements worn by the person or other alarm signal generating elements. The signs are attached to the cable and anchor it as well as alert a child that the boundary is being approached. The signs can thus serve several functions: anchoring the cable, alerting a child that the cable is being approached and actually teaching the child to read and to be aware of warning signs. The signs are in the octagonal form of a stop sign so a child can be taught to recognize such warning signs as well.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a boundary-defining system embodying the present invention.

FIG. 2 shows a detail of FIG. 1.

FIG. 3 is a bracelet that can be worn by a person being confined by the boundary-defining system of the present invention.

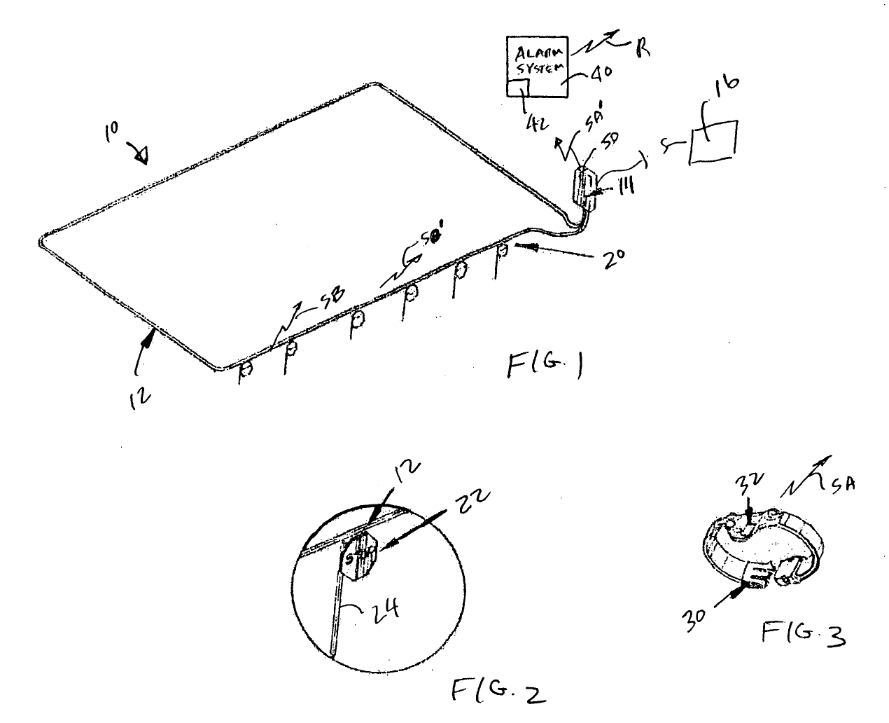

### DETAILED DESCRIPTION OF THE INVENTION

Referring to the figures, it can be understood that the present invention is embodied in a boundary-defining system 10. Boundary system 10 includes a border-defining wire 12 which is buried in the ground and which generates a border-defining signal SB in the immediate vicinity of the border-defining wire when activated. An on/off switch element 14 is connected to the border-defining wire, and a power source 16 is connected to the border-defining wire via the on/off switch to activate the border-defining wire when the on/off switch is in an “on” condition.

A visible signal system 20, such as signs 22 that have written indicia, such as the word “stop” thereon. Each sign is mechanically attached to the border-defining wire. The signs are spaced apart from each other and each sign includes a ground-engaging post, such as post 24. Each sign is physically attached to the wire and the signs serve to anchor the border-defining wire in place as well as alert a child that the border is being approached as well as teaching the child to read. The signs are octagonal in shape and resemble a stop sign so a child is also taught to recognize such warning signs. The signs thus serve several functions.

A signal element, such as a bracelet 30 shown in FIG. 3, which is worn by a person to be monitored and includes a circuit 32 that is adapted to receive border-defining signal SB generated by the border-defining wire when the signal element is in the vicinity of the border-defining wire and which generates an alarm signal SA upon receipt of the border-defining signal generated by the border-defining wire.

An alarm system 40, such as a computer or the like, is located spaced apart and remote from the border-defining wire and spaced apart and remote from the signal element. Alarm system 40 has circuitry 42 that is adapted to receive alarm signal SA generated by signal element 30 when the signal element is in the vicinity of the border-defining wire and to generate an audible signal R upon receipt of the alarm signal from the signal element.

Signal R will alert an adult or other caretaker that the person wearing the signal element is physically located in the vicinity of the border-defining wire so the adult can take the appropriate actions. Recorder on bracelet will have voice commands to alert child/patient they are in a restricted area. The buried cable and alarm activating element can be in the form of a field coil and magnetic element that interrupts the field when it crosses the field, in the manner of a traffic light control switch, or the like so that signal SB is a field or the like. The exact details of the circuitry associated with such proximity switches is not important to the present invention and is known to those skilled in the art from disclosures such as found in U.S. Pat. No. 3,753,421 which is incorporated herein by reference. As such, the exact details of the circuitry associated with activating the alarm when the alarm-activating element crosses the boundary-defining buried cable will not be discussed or claimed.

It is also noted that signal SB could be the signal that activates alarm system 40 to generate signal R if circuitry 42 is set accordingly. Thus, if border-defining wire generates a field and signal element 30 is an element that interrupts the field, circuitry, such as circuitry 50 in switch element 14 can receive the signal SB′ generated by the border-defining wire when the field associated therewith is interrupted by the signal element and generate an alarm signal SA′ in response to receipt of the signal SB′ to activate the alarm system 40 and generate a signal R in response to signal SA′.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A boundary-defining system comprising:
A) a border-defining wire which is buried in the ground and which generates a border-defining signal in the immediate vicinity of the border-defining wire when activated;
B) an on/off switch element connected to the border-defining wire;
C) a power source connected to the border-defining wire via the on/off switch to activate the border-defining wire when the on/off switch is in an “on” condition;
D) a visible signal system mechanically attached to the border-defining wire, the visible signal system including a plurality of octagonal signs which are spaced apart from each other, each sign including an anchor post which is located in the ground, each sign including written indicia thereon;
E) a signal element which is worn by a person to be monitored and which includes a circuit that is adapted to receive the border-defining signal generated by the border-defining wire when the signal element is in the vicinity of the border-defining wire and which generates an alarm signal and voice signal upon receipt of the border-defining signal generated by the border-defining wire; and
F) an alarm system that is located spaced apart from the border-defining wire and spaced apart from the signal element and which has circuitry that is adapted to receive the alarm signal generated by the signal element when the signal element is in the vicinity of the border-defining wire and to generate an audible signal upon receipt of the alarm signal from the signal element.

2. A boundary-defining system comprising:
A) a border-defining wire which is buried in the ground and which generates a border-defining signal in the immediate vicinity of the border-defining wire when activated;
B) an on/off switch element connected to the border-defining wire;
C) a power source connected to the border-defining wire via the on/off switch to activate the border-defining wire when the on/off switch is in an “on” condition;
D) a signal element which is worn by a person to be monitored and which includes a circuit that is adapted to receive the border-defining signal generated by the border-defining wire when the signal element is in the vicinity of the border-defining wire and which generates an alarm signal and voice signal upon receipt of the border-defining signal generated by the border-defining wire; and
E) an alarm system that is located spaced apart from the border-defining wire and spaced apart from the signal element and which has circuitry that is adapted to receive the alarm signal generated by the signal element when the signal element is in the vicinity of the border-defining wire and to generate an audible signal upon receipt of the alarm signal from the signal element.

3. The boundary-defining system defined in claim 1 wherein the signal element includes a bracelet.

4. The boundary-defining system defined in claim 1 wherein the written indicia on each sign includes the word “stop” and each sign is octagonal in shape.
